(19) United States
(12) Patent Application Publication
(10) Pub. No.: US 2009/0248368 A1
(43) Pub. Date: Oct. 1, 2009

(54) Systems and methods of constructing Radial Basis Function (RBF) based meta-models used in engineering design optimization

(75) Inventor: Tushar Goel, Livermore, CA (US)

Correspondence Address: ROGER H. CHU, 19499 ERIC DRIVE, SARATOGA, CA, 95070, US

(73) Assignee: LIVERMORE SOFTWARE TECHNOLOGY CORPORATION, Livermore, CA (US)

(21) Appl. No.: 12/056,155

(22) Filed: Mar. 26, 2008

(51) Int. Cl. G06F 17/50; G06F 17/11

(52) U.S. Cl. 703/1

(57) ABSTRACT

Systems and methods of consuming radial basis function (RBF) based meta-models are described. In one aspect, a product is to be designed and optimized with a set of design variables, objectives and constraints. A number of design of experimentals (DOE) points are identified. Each of the DOE points represents a particular or unique combination of design variables. Computer-aided engineering (CAE) analysis/analyses is/are then performed for each of the DOE points. A RBF based meta-model is created to approximate the CAE analysis results at all of the DOE points. A crowding distance is calculated for each DOE point. The DOE points are sorted accordingly in a predetermined criterion such as descending order, from which a predefined number of the DOE points are chosen as RBF neuron centers. RBF parameters such as function type, width and weight factor are adjusted so that the meta-model can substantially match the CAE analysis results.

### FIELD OF THE INVENTION

The present invention generally relates to engineering design optimization, more particularly to Radial Basis Function (RBF) based meta-models used in engineering design optimization.

### BACKGROUND OF THE INVENTION

Today, computer aided engineering (CAE) has been used for supporting engineers in tasks such as analysis, simulation, design, manufacture, etc. In a conventional engineering design procedure, CAE analysis (e.g., finite element analysis (FEA), finite difference analysis, meshless analysis, computational fluid dynamics (CFD) analysis, modal analysis for reducing noise-vibration-harshness, etc.) has been employed to evaluate responses (e.g., stresses, displacements, etc.). Using automobile design as an example, a particular version or design of a car is analyzed using FEA to obtain the responses due to certain loading conditions. Engineers will then try to improve the car design by modifying certain parameters or design variables (e.g., thickness of the steel shell, locations of the frames, etc.) based on specific objectives and constraints. Another FEA is conducted to reflect these changes until a “best” design has been achieved. However, this approach generally depends on knowledge of the engineers or based on a trial-or-error method.

Furthermore, as often in any engineering problems or projects, these design variables, objectives and constraints are generally in conflict and interact with each other nonlinearly. Thus, it is not very clear how to modify them to achieve the “best” design or trade-off. This situation becomes even more complex in a multi-disciplinary optimization that requires several different CAE analyses (e.g., FEA, CFD and NVH) to meet a set of conflicting objectives. To solve this problem, a systematic approach to identify the “best” design, referred to as design optimization, is used. In conventional design optimization, a large number of simulations or FEA need to be computed. This approach would work if the product is relatively simple. When the product becomes more complex, for example, an automobile, a single crashworthiness analysis may require many hours if not days of computation time even with a state-of-the-art multi-processor computer system. Long computing time and the associated costs render this approach unfeasible. To overcome this shortcoming, computationally inexpensive meta-models are developed and used for the design optimization.

Meta-models are mathematical equations that can be calibrated to approximate responses of relative few samples of design points, each representing a specific design variation. Only the chosen design points are analyzed using CAE analysis, hence the computation time and costs become manageable.

There are many kinds of meta-model. Radial basis functions (RBFs) based meta-models have been used because of its ability of modeling non-linear responses with low fitting cost. However, the quality of approximation from RBF based meta-models is highly dependent upon the topology of the network (e.g., the number of radial basis functions, locations of centers of neurons, radius of influence, etc.). To date, there is no “best” method as to how to select and network topology of RBF based meta-model. Therefore, it would be desirable to have an efficient and effective approach to construct RBF based meta-models in an engineering design optimization.

### BRIEF SUMMARY OF THE INVENTION

This section is for the purpose of summarizing some aspects of the present invention and to briefly introduce some preferred embodiments. Simplifications or omissions in this section as well as in the abstract and the title herein may be made to avoid obscuring the purpose of the section. Such simplifications or omissions are not intended to limit the scope of the present invention.

The present invention discloses systems and methods of performing design and optimization of a product using radial basis function (RBF) based meta-models. According to one aspect, a product is to design and optimize with a set of design variables, objectives and constraints. A suitable number of design of experiments (DOE) points is then identified such that each point represents a particular or unique combination of design variables. Computer-aided engineering (CAE) analysis or analyses (e.g., finite element analysis, finite difference analysis, meshless analysis, etc.) is/are then performed for each of the DOE points. A RBF based meta-model is created to approximate the CAE analysis results at all of the DOE points. Once the RBF based meta-model is satisfactory (e.g., accuracy within a tolerance), an optimized “best” design can be found by using this RBF based meta-model as function evaluator for the optimization method. Finally, a CAE analysis is performed to verify the optimized “best” design.

According to another aspect, the creation of the RBF based meta-models includes the selection of number of RBF neurons and location of center of the neurons, selection of the radius of RBFs and then appropriate weight selection such that the meta-model can approximate the desired response.

According to yet another aspect, the selection of number of neurons is based on crowding distance (CD) of each of the DOE points. The crowding distance of a particular point of the DOE points is a sum of all of the differences between two nearest neighboring points of the particular point in each of the set of design variables.

According to yet anther aspect, the DOE points are sorted into a list using the calculated crowding distance in a predetermined criterion such as descending order. A predefined number of the DOE points are chosen as the RBF centers. RBF parameters such as function type, width and weight factor are then adjusted so that the RBF based meta-model can substantially match the analysis results obtained from the CAE analyses at all of the DOE points.

According to one embodiment, the present invention is method of performing design optimization of a product, the method comprises at least the following: identifying a set of design variables, objectives and constraints for designing and optimizing a product; identifying a plurality of design of experiments (DOE) points, each of the DOE points includes a unique combination of design variables; creating a plurality of computer-aided engineering (CAE) analysis models corresponding to the plurality of the DOE points; obtaining analysis results by performing CAE analyses using the plurality of CAE analysis models; creating a radial basis function (RBF) based meta-model such that the RBF based meta-model can approximate the analysis results; obtaining an optimized design of the structural product using the RBF based meta-model, the optimized design is bounded by the set of design variables, objectives and constraints; and verifying the optimized design of the structural product by performing CAE analysis of a CAE analysis model created for the optimized design.

The method further comprises said creating a radial basis function (RBF) based meta-model further comprises: calculating a crowding distance of each of the plurality of DOE points; sorting the plurality of DOE points based on the calculated crowding distance according to a predetermined criterion; designating a predefined number of the DOE points as a plurality of RBF centers; and selecting RBF function parameters at each of the RBF centers.

One of the objects, features, and advantages of the present invention is to allow systematic scheme of selecting RBF centers to avoid random trial-and-error selection approach. Other objects, features, and advantages of the present invention will become apparent upon examining the following detailed description of an embodiment thereof, taken in conjunction with the attached drawings.

### BRIEF DESCRIPTION OF THE DRAWINGS

These and other features, aspects, and advantages of the present invention will be better understood with regard to the following description, appended claims, and accompanying drawings as follows:

FIGS. 1A-B are diagrams showing a car crashes into a solid barrier with different headings (i.e., a design variable);

FIG. 2A is a diagram illustrating a number of design of experiments (DOE) points based on a single design variable (X₁);

FIG. 2B is a diagram illustrating a number of design of experiments (DOE) points based on two design variables (X₁ and X₂);

FIG. 3 is a diagram showing exemplary Radial Basis Function (RBF) neurons in accordance with one embodiment of the present invention;

FIGS. 4A-4B are diagrams showing two exemplary types of RBF, according to an embodiment of the present invention;

FIG. 5 is a diagram showing an exemplary calculation of crowding distance (CD) of a DOE point based on two design variables in accordance with one embodiment of the present invention;

FIGS. 6A-C collectively is a flowchart illustrating an exemplary computer-implemented process of performing engineering design optimization using RBF based meta-model, according to an embodiment of the present invention; and

FIG. 7 is a function diagram showing salient components of a computing device, in which an embodiment of the present invention may be implemented.

### DETAILED DESCRIPTION

In the following description, numerous specific details are set forth in order to provide a thorough understanding of the present invention. However, it will become obvious to those skilled in the art that the present invention may be practiced without these specific details. The descriptions and representations herein are the common means used by those experienced or skilled in the art to most effectively convey the substance of their work to others skilled in the art. In other instances, well-known methods, procedures, components, and circuitry have not been described in detail to avoid unnecessarily obscuring aspects of the present invention.

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments mutually exclusive of other embodiments. Further, the order of blocks in process flowcharts or diagrams representing one or more embodiments of the invention do not inherently indicate any particular order nor imply any limitations in the invention.

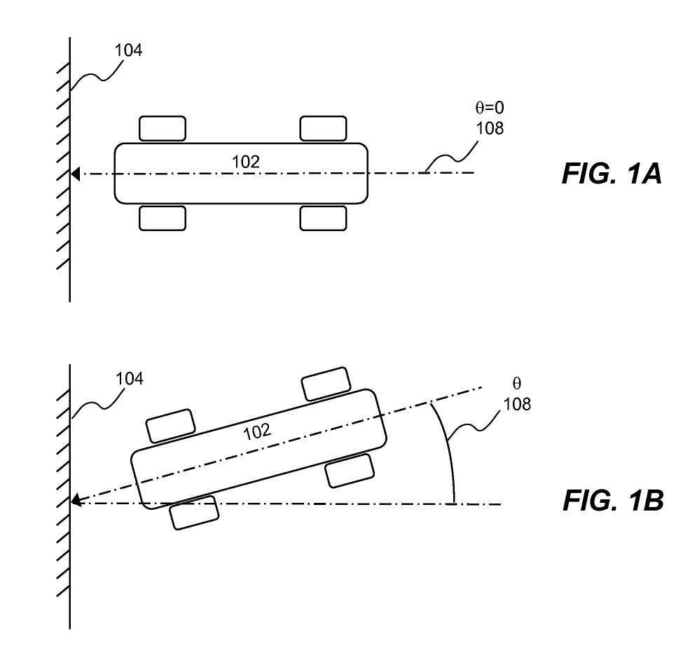

Embodiments of the present invention are discussed herein with reference to FIGS. 1A-7. However, those skilled in the art will readily appreciate that the detailed description given herein with respect to these figures is for explanatory purposes as the invention extends beyond these limited embodiments.

According to one aspect of the present invention, a product is designed and optimized using a Radial Basis Function (RBF) based meta-model. The meta-models are constructed to approximate computer aided engineering (CAE) analysis (e.g., finite element analysis (FEA), computational fluid dynamics analysis, modal analysis for reducing noise-vibration-harshness, etc.) results at a set of design of experiments (DOE) points. Each of the DOE points is selected with a combination of design variables, objectives and constraints. A “best” or an optimized design is a result of the design optimization based on those design variables, objectives and constraints. One exemplary design variable is shown in FIGS. 1A-1B, which are diagrams showing a car 102 crashes to a solid wall 104 at different headings (i.e., angle θ 108). The heading may be chosen as a design variable to optimize a car design (i.e., an engineering product). Associated design constraint may include a crumble zone between impact location and vehicle occupants. The design objective is to ensure the occupants are safe during a car crash of certain speed.

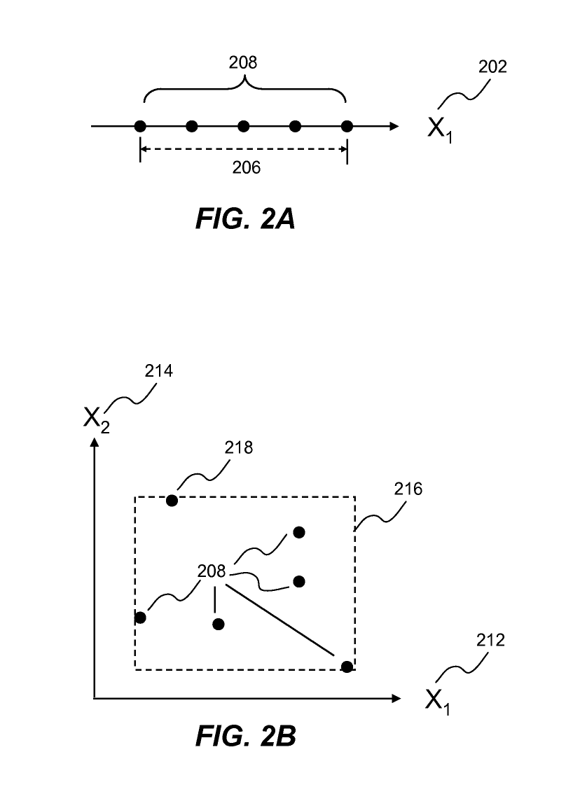

While only one exemplary design variable is shown in FIGS. 1A-B, there are generally more than one design variables chosen to optimize an engineering product in reality. FIG. 2A is a diagram showing a set of five DOE points 208 plotted against design variable X₁ 202. A design space 206 shown as dotted line defines a range in which the structural product is to be designed and optimized.

In another example, a X-Y plot in FIG. 2B shows a group of DOE points 218 located in a design space 216 defined by two design variables X₁ 212 and X₂ 214. The design space 216 defines a constraint of the design optimization process, since there are two design variables the design space 216 is an area instead of a line shown in FIG. 2A.

To keep illustration simplicity, examples for design variables greater than two are not shown. Those of ordinary skilled in the art would understand that the number of design variables may be any positive integer N. At each DOE point, a full blown computer aided analysis (CAE) is performed. The CAE results of all of the DOE points are then used as the targets for which a meta-model is constructed to approximate.

According to one aspect, Radial Basis Function (RBF) based meta-models are used in the present invention. RBF is a real-valued function whose value depends only on the distance from the origin, so that φ(x)=φ(∥x∥); or alternatively on the distance from some other point c, called a center, so that φ(x, c)=(∥x−x∥). Any function φ that satisfies the property φ(x)=φ(∥x∥) is a radial function. The norm is usually Euclidean distance. Radial basis functions are typically used to build up function approximations of the form

$$y ( x ) = {\sum }_{i = 1}^{N} {w}_{i} φ ( ‖ x - {c}_{i} ‖ ) ,$$

where the approximating function y(x) is represented as a sum of N radial basis functions, each associated with a different center cᵢ, and weighted by an appropriate coefficient wᵢ. Approximation schemes of this kind have been particularly used in time series prediction and control of nonlinear systems exhibiting sufficiently simple chaotic behavior.

Commonly used types of radial basis functions include:

Gaussian:

φ(r)=exp(−βr²) for some β>0

h(x)=exp(−(x−c)²/r²)

Multiquadric:

φ(r)=\sqrt{r²+β²} for some β>0

h(x)=\sqrt{r²+(x−c)²}/r

Thin Plate Spline

φ(r)=r² log(r)

The response y(x) is differentiable with respect to the weights wᵢ. The weights could thus be learned using any of the standard iterative methods for neural networks. But such iterative schemes are not in fact necessary: because the approximating function is linear in the weights wᵢ, the wᵢ can simply be estimated directly, using the matrix methods of linear least squares regression.

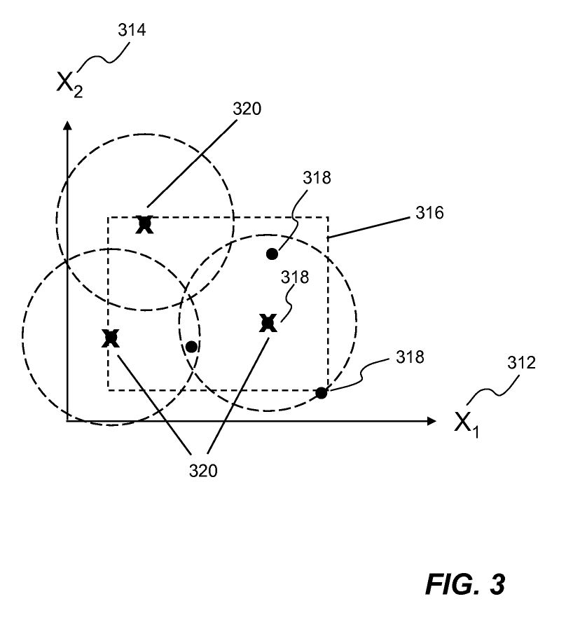

Since selecting locations of RBF center are vital to ensure a satisfactory approximation, an exemplary set of RBF neuron centers is shown in FIG. 3 in accordance with one embodiment of the present invention. Similar to the X-Y plot in FIG. 2B, there are two design variables X₁ 312 and X₂ 314. A number of DOE points 318 (shown as dots) are chosen within a design space 316. Three RBF centers 320 (shown as X) are selected according to an exemplary selection scheme.

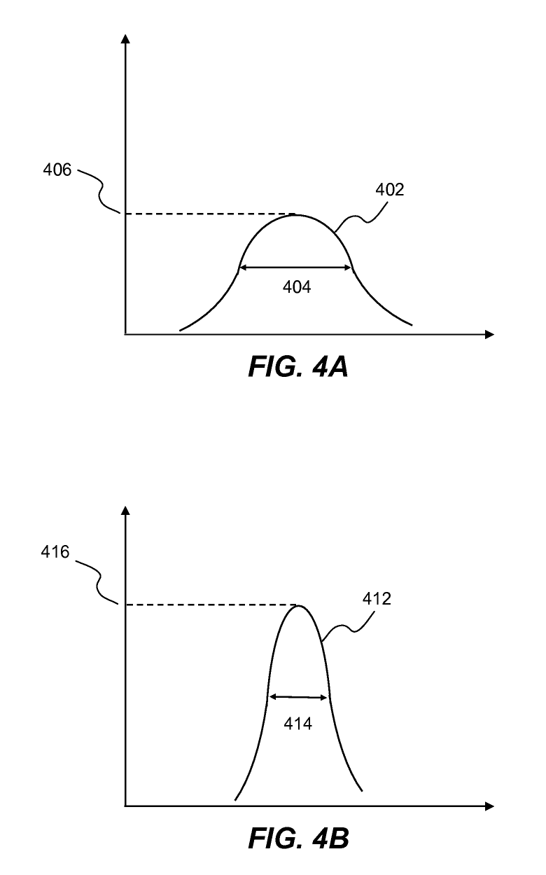

FIGS. 4A-4B are diagrams showing first and second exemplary RBFs in accordance with one embodiment of the present invention. The first RBF 402 has a wider width parameter 404 with a lower weight factor 406, while the second RBF 412 has a narrower width 414 and a higher weight factor 416. These parameters are adjusted during the construction phase of meta-models such that a better approximation can be achieved.

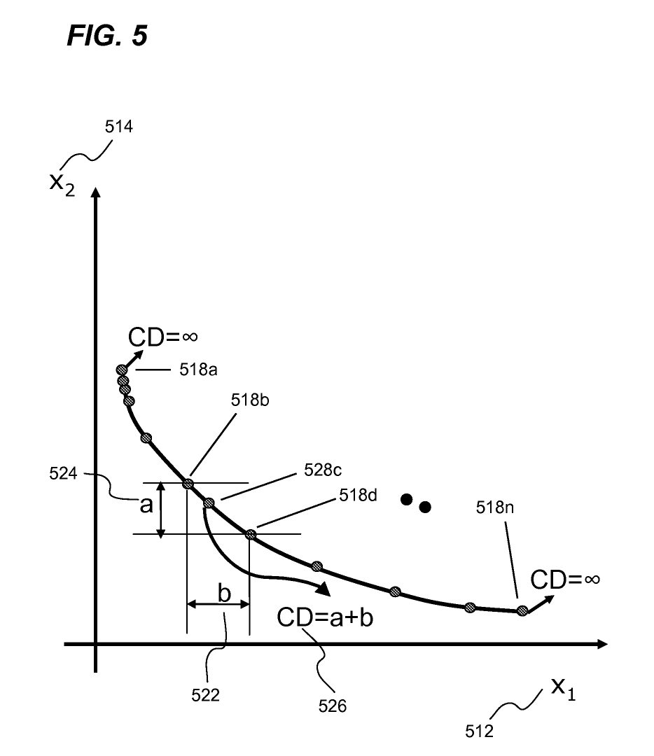

According to one aspect of the present invention, an exemplary scheme of the selection of RBF centers is based on a parameter referred to as crowding distance (CD). FIG. 5 is a diagram showing an exemplary calculation of CD of a DOE point based on two design variables in accordance with one embodiment of the present invention. In the diagram of FIG. 5, a number of DOE points 518a-n are plotted in an X-Y plot with a first design parameter X₁ 512 in a first design variable axis or dimension and a second design variable X₂ 514 in a second axis or dimension. Crowding distance (CD) of a DOE point 518c is calculated using a formula CD=a+b, where ‘b’ 522 and ‘a’ 524 are difference between first 518b and second 518d neighboring DOE points in the first and the second design variable dimensions, respectively. CD of boundary DOE points 518a and 518n is assigned a value equivalent to infinity. One skilled in the art would understand that CD=a+b+ . . . +n for a design optimization project based on N design variables, where N is a positive integer.

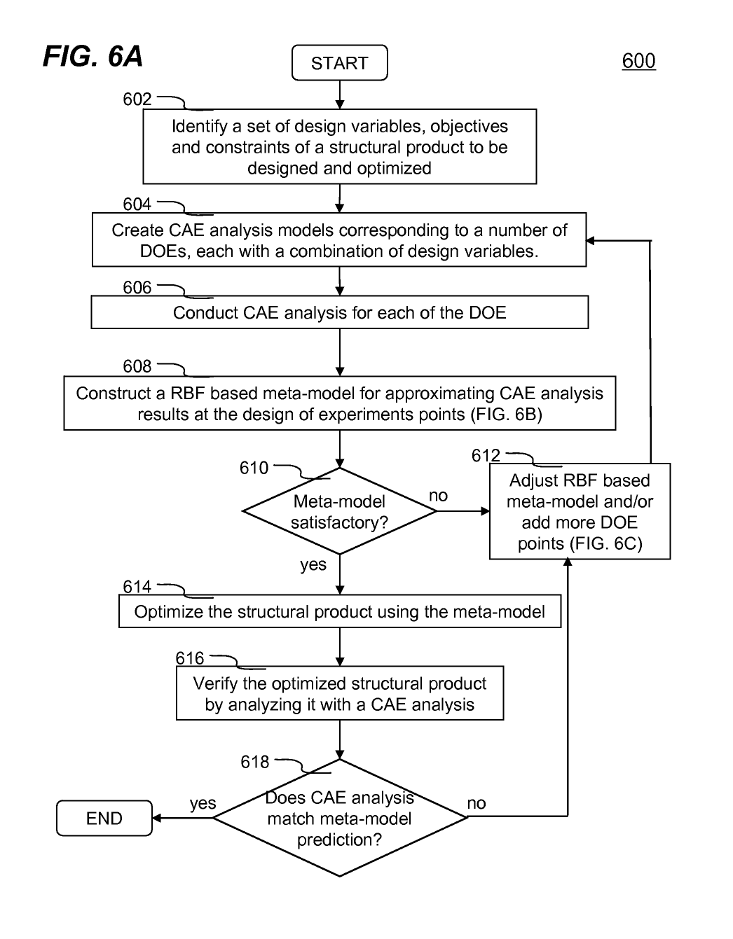

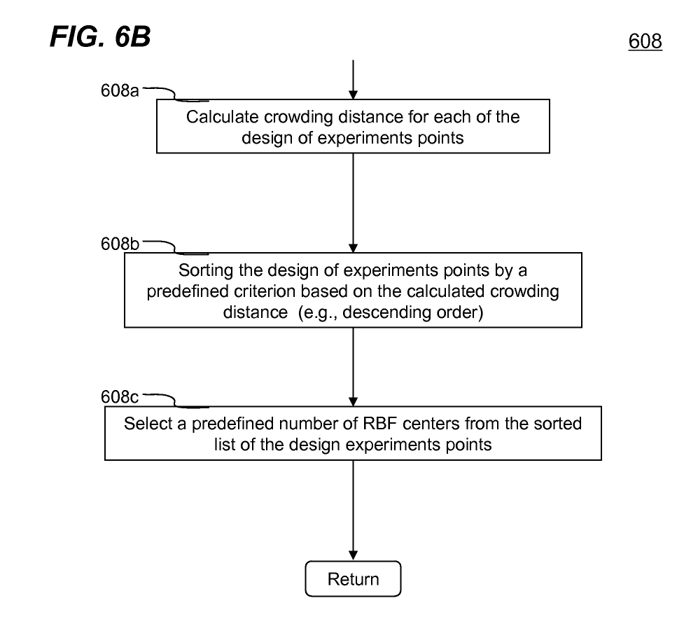

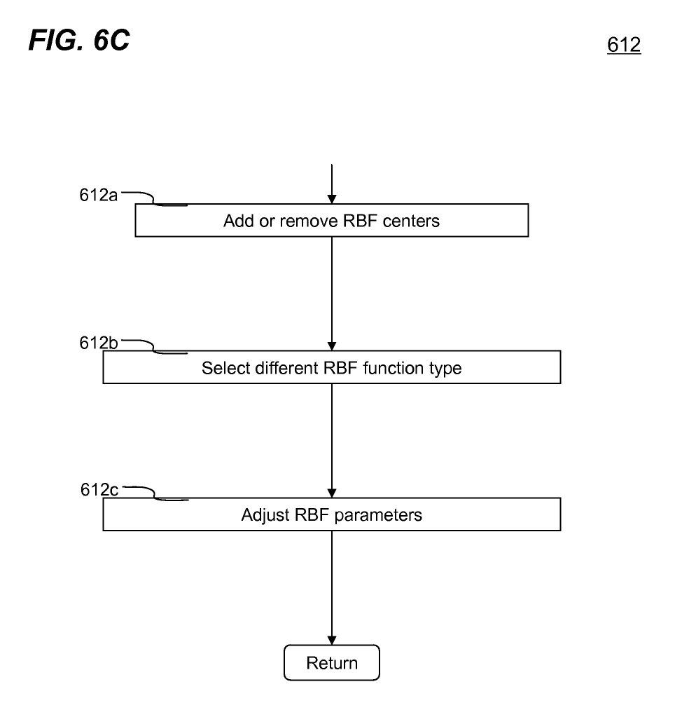

Referring now to FIGS. 6A-C, which collectively show a flowchart illustrating an exemplary process 600 of performing engineering design optimization using RBF based meta-model, according to an embodiment of the present invention. The process 600 starts by identifying a set of design variables, objectives and constraints of an engineering product (e.g., an automobile, a consumer product, etc.) to be designed and optimized at 602. Next at 604, a number of CAE analysis models (e.g., FEA models) are created corresponding to a number of design of experiments (DOE) points. Each of the DOE points represents a unique combination of design variables. For example, two DOE points may only have one difference in one of the design variables in one case. In another case, two DOE points may have totally different values in all of the design variables chosen to be optimized and designed. The DOE points are defined to cover the entire design space similar to taking statistical samples. The process 600 then conduct CAE analyses, one for each of the DOE points at 606. After CAE analysis results (or responses) have been obtained at all of the DOE points, the process 600 moves to 608 creating a RBF based meta-model. The meta-model is used for approximating the CAE results. Details of step 608 are shown in FIG. 6B and corresponding description thereof.

Next, at decision 610, it is determined whether the meta-model is satisfactory. In other words, whether the meta-model approximates the CAE results at DOE points within a threshold. If ‘no’, the process 600 adjusts either parameters of RBF based meta-model or add more DOE points at 612 before going back to step 604. Further details of step 612 are described in FIG. 6C. Otherwise if ‘yes’, at 614, the structural product is optimized using the satisfactory meta-model. Then a CAE analysis is conducted to verify the optimized structural product at 616. Next at decision 618, it is determined whether the CAE analysis results of the optimized design are within a predetermined threshold of the approximated responses obtained via the RBF based meta-model. If ‘yes’, the optimization process 600 ends. Otherwise, the process 600 follows the ‘no’ branch to step 612 then 604 to repeat the above process until the process 600 ends.

FIG. 6B shows details of step 608, which starts by calculating crowding distance (CD) of each of DOE points in all of the set of design variables at 608a. Next, the DOE points are sorted by a predefined criterion (e.g., descending order, ascending order) based on the calculated CD at 608b. Using the sorted list to select a predefined number of DOE points as RBF centers at 608c ensures a systematic scheme, which eliminates random trial-and-error approach.

FIG. 6C shows details of step 612. At 612a, the step 612 may either add or remove RBF centers. Next, at 612b, the process 600 may select different RBF type. Finally, at 612c, RBF parameters are adjusted before returning.

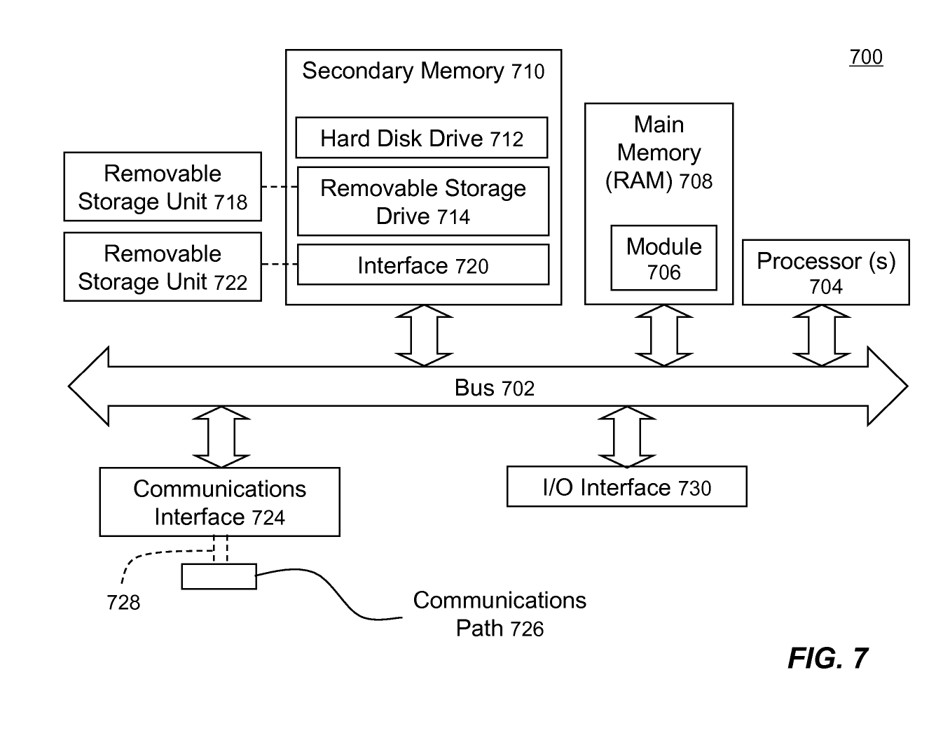

According to one aspect, the present invention is directed towards one or more computer systems capable of carrying out the functionality described herein. An example of a computer system 700 is shown in FIG. 7. The computer system 700 includes one or more processors, such as processor 704. The processor 704 is connected to a computer system internal communication bus 702. Various software embodiments are described in terms of this exemplary computer system. After reading this description, it will become apparent to a person skilled in the relevant art(s) how to implement the invention using other computer systems and/or computer architectures.

Computer system 700 also includes a main memory 708, preferably random access memory (RAM), and may also include a secondary memory 710. The secondary memory 710 may include, for example, one or more hard disk drives 712 and/or one or more removable storage drives 714, representing a floppy disk drive, a magnetic tape drive, an optical disk drive, etc. The removable storage drive 714 reads from and/or writes to a removable storage unit 718 in a well-known manner. Removable storage unit 718, represents a floppy disk, magnetic tape, optical disk, etc. which is read by and written to by removable storage drive 714. As will be appreciated, the removable storage unit 718 includes a computer usable storage medium having stored therein computer software and/or data.

In alternative embodiments, secondary memory 710 may include other similar means for allowing computer programs or other instructions to be loaded into computer system 700. Such means may include, for example, a removable storage unit 722 and an interface 720. Examples of such may include a program cartridge and cartridge interface (such as that found in video game devices), a removable memory chip (such as an Erasable Programmable Read-Only Memory (EPROM), Universal Serial Bus (USB) flash memory, or PROM) and associated socket, and other removable storage units 722 and interfaces 720 which allow software and data to be transferred from the removable storage unit 722 to computer system 700. In general, Computer system 700 is controlled and coordinated by operating system (OS) software, which performs tasks such as process scheduling, memory management, networking and I/O services. Exemplary OS includes Linux®, Microsoft Windows®.

There may also be a communications interface 724 connecting to the bus 702. Communications interface 724 allows software and data to be transferred between computer system 700 and external devices. Examples of communications interface 724 may include a modem, a network interface (such as an Ethernet card), a communications port, a Personal Computer Memory Card International Association (PCMCIA) slot and card, etc. Software and data transferred via communications interface 724 are in the form of signals 728 which may be electronic, electromagnetic, optical, or other signals capable of being received by communications interface 724. These signals 728 are provided to communications interface 724 via a communications path (i.e., channel) 726. This channel 726 carries signals (or data flows) 728 and may be implemented using wire or cable, fiber optics, a phone line, a cellular phone link, an RF link, a Bluetooth® wireless link and other communications channels.

The channel 726 facilitates a data flow 728 between a data network and the computer 700 and typically executes a special set of rules (i.e., a protocol) to send data back and forth. One of the common protocols is TCP/IP (Transmission Control Protocol/Internet Protocol) commonly used in the Internet. In general, the communication interface 724 manages the assembling of a data file into smaller packets that are transmitted over the data network or reassembles received packets into the original data file. In addition, the communication interface 724 handles the address part of each packet so that it gets to the right destination or intercepts packets destined for the computer 700. In this document, the terms “computer program medium” and “computer usable medium” are used to generally refer to media such as removable storage drive 714, and/or a hard disk installed in hard disk drive 712. These computer program products are means for providing software to computer system 700. The invention is directed to such computer program products.

The computer system 700 may also include an input/output (I/O) interface 730, which provides the computer system 700 to access monitor, keyboard, mouse, printer, scanner, plotter, and alike.

Computer programs (also called computer control logic) are stored as application modules 706 in main memory 708 and/or secondary memory 710. Computer programs may also be received via communications interface 724. Such computer programs, when executed, enable the computer system 700 to perform the features of the present invention as discussed herein. In particular, the computer programs, when executed, enable the processor 704 to perform features of the present invention. Accordingly, such computer programs represent controllers of the computer system 700.

In an embodiment where the invention is implemented using software, the software may be stored in a computer program product and loaded into computer system 700 using removable storage drive 714, hard drive 712, or communications interface 724. The application module 706, when executed by the processor 704, causes the processor 704 to perform the functions of the invention as described herein.

The main memory 708 may be loaded with one or more application modules 706 that can be executed by one or more processors 704 with or without a user input through the I/O interface 730 to achieve desired tasks. In operation, when at least one processor 704 executes one of the application modules 706, the results are computed and stored in the secondary memory 710 (i.e., hard disk drive 712). The status of the CAE analysis or design optimization (e.g., RBF based meta-model approximation) is reported to the user via the I/O interface 730 either in a text or in a graphical representation.

Although the present invention has been described with reference to specific embodiments thereof, these embodiments are merely illustrative, and not restrictive of, the present invention. Various modifications or changes to the specifically disclosed exemplary embodiments will be suggested to persons skilled in the art. For example, whereas the number of design variables has been shown as two, in reality, a larger number of design variables have been used. Additionally, whereas finite element analysis has been described and shown for stress analysis, other types of CAE analysis such as finite difference analysis or meshless analysis, etc. may be used to achieve the same. In summary, the scope of the invention should not be restricted to the specific exemplary embodiments disclosed herein, and all modifications that are readily suggested to those of ordinary skill in the art should be included within the spirit and purview of this application and scope of the appended claims.

What is claimed is:

1. A method of performing design optimization of a product, the method comprises:
defining a set of design variables, objectives and constraints for designing and optimizing a product;
defining a plurality of design of experiments (DOE) points, each of the DOE points includes a unique combination of design variables;
creating a radial basis function (RBF) based meta-model such that the RBF based meta-model can approximate the analysis results obtained by performing at least one computer aided engineering (CAE) analysis using the plurality of CAE analysis models each corresponding to one of the plurality of DOE points; and
obtaining an optimized design of the structural product using the RBF based meta-model, the optimized design is bounded by the set of design variables, objectives and constraints.

2. The method of claim 1, further comprises verifying the optimized design of the structural product by performing CAE analysis of a CAE analysis model created for the optimized design.

3. The method of claim 2, wherein the CAE analysis includes, but is not limited to, a finite element analysis, a computational fluid dynamics analysis, a modal analysis for reducing noise-vibration-harshness.

4. The method of claim 2, said creating a radial basis function (RBF) based meta-model further comprises:
calculating a crowding distance of each of the plurality of DOE points;
sorting the plurality of DOE points based on the calculated crowding distance according to a predetermined criterion;
designating a predefined number of the DOE points as a plurality of RBF centers; and
selecting RBF function parameters at each of the RBF centers.

5. The method of claim 4, wherein the RBF function parameters include function type, weight factor, and function width.

6. The method of claim 4, further comprises:
adding or removing one or more of the RBF centers; and
adjusting RBF parameters to substantially match the analysis results within a predetermine tolerance or threshold.

7. The method of claim 4, wherein the crowding distance of a particular one of the DOE points is a sum of all differences between two nearest neighboring points of the particular point of the DOE points in each of the set of design variables.

8. The method of claim 4, wherein the function width is so determined at each of the RBF centers to ensure good approximation.

9. The method of claim 4, wherein the predefined criterion is a descending order.

10. A system for performing design optimization of a product comprising;
an input/output (I/O) interface;
a memory for storing computer readable code for an application module;
at least one processor coupled to the memory, said at least one processor executing the computer readable code in the memory to cause the application module to perform operations of:
defining a set of design variables, objectives and constraints for designing and optimizing a product;
defining a plurality of design of experiments (DOE) points, each of the DOE points includes a unique combination of design variables;
creating a radial basis function (RBF) based meta-model such that the RBF based meta-model can approximate analysis results obtained by performing at least one computer aided engineering (CAE) analysis using the plurality of CAE analysis models each corresponding to one of the plurality of DOE points; and
obtaining an optimized design of the structural product using the RBF based meta-model, the optimized design is bounded by the set of design variables, objectives and constraints.

11. The system of claim 10, said operations further comprises verifying the optimized design of the structural product by performing CAE analysis of a CAE analysis model created for the optimized design.

12. The system of claim 11, wherein said creating a radial basis function (RBF) based meta-model further comprising:
calculating a crowding distance of each of the plurality of DOE points;
sorting the plurality of DOE points based on the calculated crowding distance according to a predetermined criterion;
designating a predefined number of the DOE points as a plurality of RBF centers; and
selecting RBF function parameters at each of the RBF centers.

13. The system of claim 12, wherein the crowding distance of a particular point of the DOE points is a sum of all differences between two nearest neighboring points of the particular point of the DOE points in each of the set of design variables.

14. The method of claim 12, wherein the function width is so determined at each of the RBF centers to ensure good approximation.

15. The method of claim 12, wherein the predefined criterion is a descending order.

16. A computer usable medium having computer a readable medium stored thereon to perform a method of performing design optimization of a product comprising:
computer readable code for defining a set of design variables, objectives and constraints for designing and optimizing a product;
computer readable code for defining a plurality of design of experiments (DOE) points, each of the DOE points includes a unique combination of design variables;
computer readable code for creating a radial basis function (RBF) based meta-model such that the RBF based meta-model can approximate the analysis results obtained by performing at least one computer aided engineering (CAE) analysis using the plurality of CAE analysis models each corresponding to one of the plurality of DOE points; and
computer readable code for obtaining an optimized design of the structural product using the RBF based meta-model, the optimized design is bounded by the set of design variables, objectives and constraints.

17. The computer usable medium of claim 16, further comprises computer readable code for verifying the optimized design of the structural product by performing CAE analysis of a CAE analysis model created for the optimized design.

18. The computer usable medium of claim 17, the computer readable code for said creating a radial basis function (RBF) based meta-model further comprises:
computer readable code for calculating a crowding distance of each of the plurality of DOE points;
computer readable code for sorting the plurality of DOE points based on the calculated crowding distance according to a predetermined criterion;
computer readable code for designating a predefined number of the DOE points as a plurality of RBF centers; and
computer readable code for selecting RBF function parameters at each of the RBF centers.

19. The computer usable medium of claim 18, wherein the crowding distance of a particular point of the DOE points is a sum of all differences between two nearest neighboring points of the particular point of the DOE points in each of the set of design variables.

20. The computer usable medium of claim 18, wherein the predefined criterion is a descending order.
